(19) United States
(12) Patent Application Publication
(10) Pub. No.: US 2024/0170689 A1
(43) Pub. Date: May 23, 2024

(54) ELECTROLYTIC CELL FORMATION

(71) Applicant: Our Next Energy, Inc., Novi, MI (US)

(72) Inventors: Qingcheng Zeng, San Jose, CA (US); Steven Kaye, Oakland, CA (US)

(21) Appl. No.: 18/513,463

(22) Filed: Nov. 17, 2023

Related U.S. Application Data
(60) Provisional application No. 63/426,425, filed on Nov. 18, 2022.

(51) Int. Cl. H01M 6/18; H01M 50/204; H01M 50/342; H01M 50/529; H01M 50/618

(52) U.S. Cl. CPC H01M 6/188; H01M 50/204; H01M 50/342; H01M 50/529; H01M 50/618

(57) ABSTRACT

Apparatus and method for forming solid-electrolyte-interface layers on electrodes of a plurality of electrolytic cells involves use of a cell formation fixture configured to define a scalable and pressurizable volume containing the electrolytic cells, while exposing terminals of the cells to ambient atmospheric pressure.

### CROSS-REFERENCE TO RELATED APPLICATIONS

This application claims priority to U.S. Provisional Application No. 63/426,425 filed on Nov. 18, 2022 and which is incorporated herein by reference in its entirety.

### FIELD OF THE DISCLOSURE

This disclosure relates to fixtures used for charging a plurality of electrolytic cells during the finishing process step of manufacturing, and more particularly to a cell formation fixture that is configured to apply pressure to the plurality of electrolytic cells during formation of a solid-electrolyte-interface layer on electrodes of the cells.

### BACKGROUND OF THE DISCLOSURE

Manufacturing of lithium-ion cells is a multiple step process typically involving electrode fabrication, cell assembly, electrolytic filling, pre-charging and cell finishing. Cell finishing generally includes cell formation, aging and grading. During the cell formation step an electrical charge is applied to the terminals of the cells to form a solid-electrolyte-interphase (SEI) layer on the electrodes. The SEI layer is an ion-conductive, electron insulating layer that significantly improves safety, performance, and useful life span of the cells.

It has been known that application of pressure to cells during formation of the SEI layers can improve the structure and properties of the SEI layers, resulting in enhanced cell performance and life. Conventional techniques of applying pressure to cells during SEI layer formation have involved use of various mechanical presses for compressing cells between platens (e.g., hydraulic press, pneumatic press, servo-press, etc.). These mechanical presses tend to be complex, requiring a plurality of guiding pillars arranged between the platens (or supporting seats) and drives for compressing cells between the platens. Additionally, pressure is not applied uniformly to surfaces of the cells using a mechanical press, leading to undesirable variations in cell performance.

### SUMMARY OF THE DISCLOSURE

Disclosed is an apparatus and fixture for applying uniform pressure to a plurality of cells and to all surfaces of the cells except for terminal ends of the cells during formation of the SEI layers. This objective is achieved using a fixture that sealingly holds a plurality of cells in spaced relationship to define a pressurizable volume or chamber into which a fluid can be introduced under pressure. The pressurized fluid applies a uniform pressure to surfaces of the cells without mechanical contact with the cells, while allowing exposure of cell terminals to ambient atmosphere.

Also disclosed is a method of forming a solid-electrolyte-interface layer on electrodes of electrolytic cells, using a fixture configured to hold the cells in a sealable and pressurizable volume, while exposing terminals of the cells to ambient atmosphere.

### BRIEF DESCRIPTION OF THE DRAWINGS

FIG. 1 is an elevational cross-section of an electrolytic cell formation fixture in accordance with the disclosure.

FIG. 2 is an enlarged section showing details of the fixture shown in FIG. 1.

FIG. 3 is a top view of an array of cells positioned in a cylindrical electrolytic cell formation fixture.

FIG. 4 is a top view of an array of cells positioned in a rectangular electrolytic cell formation fixture.

### DETAILED DESCRIPTION

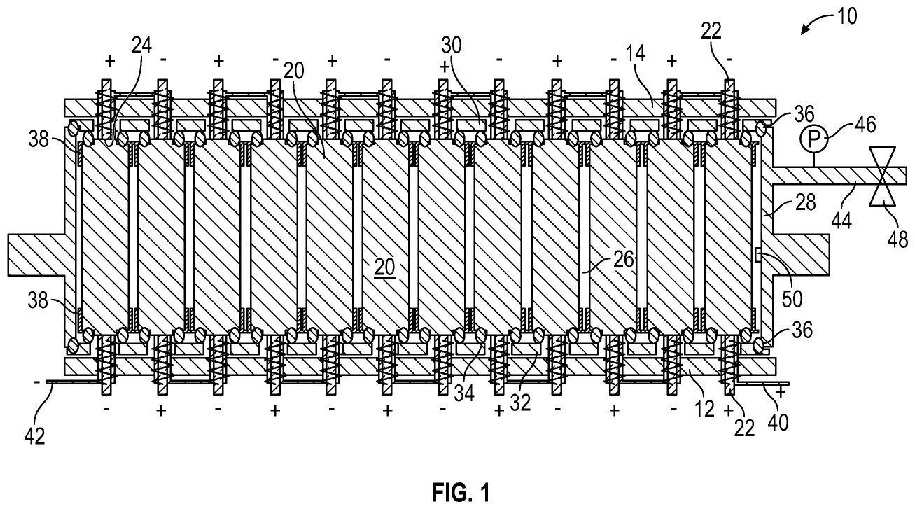

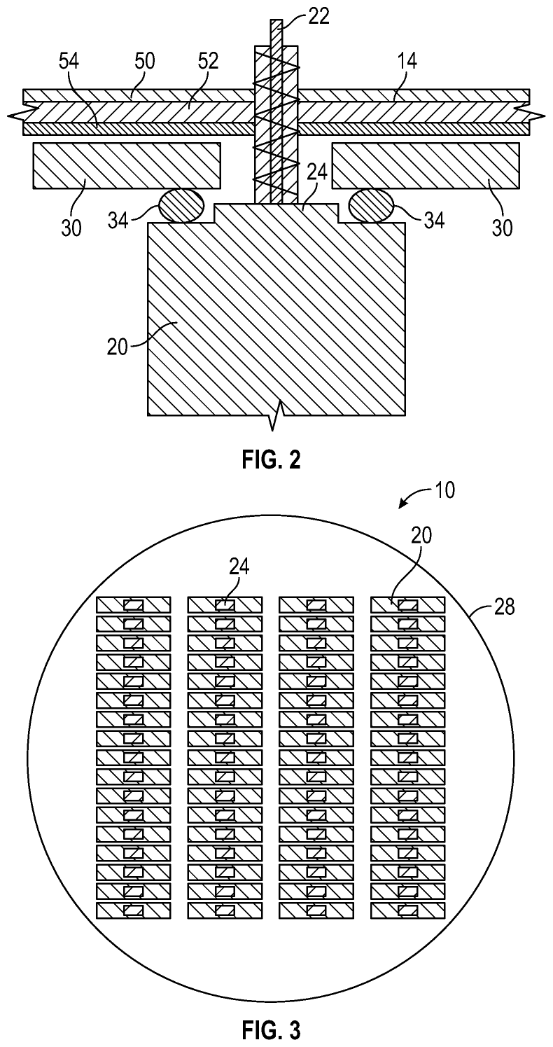

The disclosed cell formation fixture 10 (shown in vertical cross-section in FIG. 1) includes opposite upper clamping plate 14 and lower clamping plate 12 which are held in fixed relation to each other to releasably hold a plurality of electrolytic cells 20. In the illustrated fixture 10, cells 20 are releasably held by electrically conductive pogo pins 22 (illustrated schematically). The pogo pins 22 typically comprise a plunger that is restricted to a range of movement within a barrel, with a spring biasing the piston away from the end of the barrel opposite the plunger. The barrels of pogo pins 22 are held in through bores of the clamping plates 12, 14 with the plungers being biased toward the terminals 24 at opposite ends of cells 20 (see FIG. 2). Other types of springs, clamps or retainers may be used as an alternative to pogo pins 22 to releasably hold the plurality of electrolytic cells 20 between plates 12 and 14.

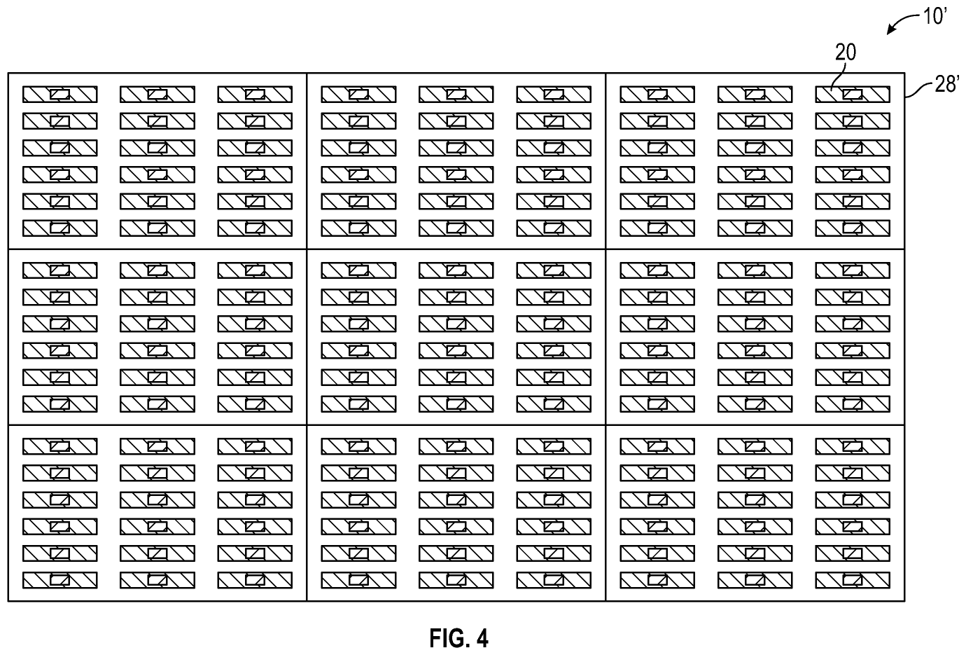

FIG. 1 shows the cell formation fixture with twelve cells 20 in vertical cross-section. However, as indicated in FIGS. 3 and 4, cells 20 can be arranged in fixture 10 in a two-dimensional array. For example, in FIG. 3 there is shown a 17×4 array of cells 20 in a cylindrical fixture 10; and in FIG. 4 there is shown an 18×9 array of cells 20 in a rectangular fixture 10′.

A pressurizable, sealable chamber 26 can be partially defined by a cylindrical side wall 28 or rectangular side wall 28′. Wall 28 (or 28′) extends around the perimeter of the cell array, and together with upper pressure plate 30, lower pressure plate 32, and seals 34 and 36 define the sealable, pressurizable chamber 26. Pressure plates 30, 32 each have a plurality of apertures to allow engagement of pogo pins 22 with terminals 24 at opposite ends of cells 20. Seals 34 can be any suitable elastomeric O-ring for providing a pressure seal between plates 32, 34 and the vertically opposite ends of cells 20. Seal 36 can be a rectangular seal or circular seal extending along the upper and lower perimeters of side wall 28, 28′ to provide a continuous seal between wall 28 (or 28′) and upper pressure plate 30 and between the wall 28, 28′ and lower pressure plate 32, respectively.

For convenience, cells 20 can be transferred from a preceding step in the manufacturing process (e.g., pre-charging step of process) to the formation fixture 10 (or 10′) using a cell tray 38. This allows a plurality of cells to be simultaneously positioned on bottom pressure plate 32, which can be already positioned on bottom clamping plate 12 with O-ring seals 34 also prepositioned. Side wall 28 can be prepositioned before positioning of cells 20, or can be assembled onto bottom plate 12 after the cells have been positioned on lower pressure plate 32. Thereafter, seals 36 and 32 can be positioned on upper ends of wall 28 (or 28′) and upper ends of cells 20, respectively. Assembly of the fixture is completed by positioning of upper pressure plate 30 and upper clamping plate 14, and clamping, or otherwise urging together, plates 12 and 14 with sufficient force to achieve the desired seals.

Cells 20 are arranged with adjacent upper and lower terminals 24 having opposite polarities, such that positive and negative terminals of adjacent pairs of cells can be electrically connected through the pogo pins 22 as illustrated in FIG. 1. The result is that the cells in a single row are serially connected so that charging is via positive bus 40 and negative bus 42 at opposite ends of the fixture 10.

Fixture 10 includes a fluid inlet 44, such as through side wall 28 (or 28′) for introducing a pressurized fluid into chamber 26. A pressure sensor 46 and controllable valve 48 can be provided at the fluid inlet to monitor and control the pressure in chamber 26. The pressurized fluid can be compressed air or other gas, or possibly a liquid. A temperature sensor 50 can also be provided to monitor temperature in chamber 26.

Clamping plates 12, 14 can act as pogo pin trays for tightly holding pogo pins 22 (or other suitable retainers) in fixed relation to plates 12, 14, and for providing a circumferential seal between each retainer apertures and the corresponding retainers, in addition to providing sufficient mechanical strength to hold the pressure in chamber 26. These three functions can be achieved with a three layer structure (FIG. 2), including a first layer 50 (holding layer) to hold pogo pins 22 (with adequate dielectric property), a second layer 52 (structural layer) to provide mechanical strength (enough thickness to hold pressure), and a third payer 54 (sealing layer) to seal cells in the chamber. In FIG. 2, holding layer 50 is the outer layer farthest from chamber 26, sealing layer 54 is the inner layer exposed to chamber 26, and structural layer 52 is between layer 50 and layer 54. However, the layers can be arranged in any order, and the functions of layers 50 and 52 can be performed by a single layer. Holding layer 50 is a dielectric layer (e.g., a thermoplastic or thermoset material) that electrically isolates retainers 22 (e.g., pogo pins) from each other. Sealing layer 54 is comprised or consists of a suitable elastomeric sealing material such as neoprene, nitrile, silicone, or ethylene-propylene-diene monomer rubber. Structural layer 52 is preferably a high strength material of suitable thickness to hold pressure in chamber 26. Suitable materials for structural layer 52 include high strength plastics such as polycarbonate. Metals (e.g., stainless steel) can be used but care must be taken in the design to avoid electrical contact between retainers 22 and any electrically conductive layer 52.

The disclosed formation fixture was developed for use within lithium cells, especially lithium ion cells, and more particularly with lithium iron phosphate cells. However, it is expected that the disclosed formation fixture will have application in the manufacturing of non-lithium electrolytic cells.

The fixture should be capable of holding pressure in chamber 26 from slightly above normal atmospheric or ambient pressure to about 2 to 4 times normal atmospheric or ambient pressure (e.g., 2.1 bar to 5 bar absolute).

It is believed advantageous to arrange cells 20 with the length direction between opposing terminals arranged vertically as illustrated in FIG. 1.

A solid-electrolyte-interface layer on electrodes of a plurality of electrolytic cells can be formed by positioning the plurality of electrolytic cells in a formation fixture configured to define a sealable volume, sealing and pressurizing the sealable volume, and applying a charging current to terminals of the plurality of electrolytic cells.

While the present invention is described herein with reference to illustrated embodiments, it should be understood that the invention is not limited hereto. Those having ordinary skill in the art and access to the teachings herein will recognize additional modifications and embodiments within the scope thereof. Therefore, the present invention is limited only by the claims attached herein.

1. An electrolytic cell formation apparatus comprising:
a fixture configured for holding a plurality of electrolytic cells, the fixture defining a sealable volume that can be pressurized with a fluid to exert a pressure on walls of the plurality of electrolytic cells that is greater than ambient pressure, while exposing terminals to ambient pressure.

2. The apparatus of claim 1, wherein structure for holding the plurality of electrolytic cells includes opposite clamping plates, each clamping plate having a plurality of retainers for releasably engaging respective opposing terminals of the plurality of electrolytic cells.

3. The apparatus of claim 1, wherein the sealable volume is defined by a side wall circumscribing the plurality of electrolytic cells, opposite lower and upper pressure plates, seals between ends of the electrolytic cells and the pressure plates, and seals between the side wall and the upper and lower pressure plates.

4. The apparatus of claim 2, wherein the retainers are electrically conductive and pairs of retainers are electrically connected to facilitate charging of a plurality of cells connected in series.

5. The apparatus of claim 1, wherein the fixture includes a fluid inlet for introducing a pressurized fluid into the sealable volume.

6. The apparatus of claim 3, wherein the fluid inlet is provided through the side wall.

7. The apparatus of claim 1, wherein a pressure sensor is provided to monitor pressure in the sealable volume.

8. The apparatus of claim 5, wherein a control valve is provided at the fluid inlet to control pressure in the sealable volume.

9. The apparatus of claim 2, wherein the retainers are pogo pins.

10. The apparatus of claim 2, wherein the clamping plates have a multilayer structure, including a structural layer to hold a desired pressure in the sealable volume, a dielectric layer for holding the retainers, and a sealing layer comprising an elastomeric material.

11. A method of forming a solid-electrolyte-interface layer on electrodes of a plurality of electrolytic cells, comprising:
positioning a plurality of electrolytic cells in a formation fixture configured to define a sealable volume;
sealing and pressurizing the sealable volume with a fluid; and
applying a charging current to terminals of the plurality of cells.

12. The method of claim 11, wherein structure for holding the plurality of electrolytic cells includes opposite clamping plates, each clamping plate having a plurality of retainers for releasably engaging respective opposing terminals of the plurality of electrolytic cells.

13. The method of claim 11, wherein the sealable volume is defined by a side wall circumscribing the plurality of electrolytic cells, opposite lower and upper pressure plates, seals between ends of the electrolytic cells and the pressure plates, and seals between the side wall and the upper and lower pressure plates.

14. The method of claim 12, wherein the pogo pins are electrically conductive and pairs of retainers are electrically connected to facilitate charging of a plurality of cells connected in series.

15. The apparatus of claim 11, wherein the fixture includes a fluid inlet for introducing a pressurized fluid into the sealable volume.

16. The method of 13, wherein the fluid inlet is provided through the side wall for introducing pressurized fluid into the sealable volume.

17. The method of claim 11, wherein a pressure sensor is provided to monitor pressure in the sealable volume.

18. The method of claim 14, wherein a control valve is provided at the fluid inlet to control pressure in the sealable volume.

19. The method of claim 11, wherein the fluid is compressed air.

20. The method of claim 11, wherein positioning of the plurality of cells in the formation fixture is done simultaneously using a cell tray.

21. The method of claim 11, wherein the plurality of electrolytic cells are lithium ion cells.

22. The method of claim 11, wherein the plurality of electrolytic cells are lithium iron phosphate cells.

23. The method of claim 12, wherein the retainers are pogo pins.

24. The method of claim 12, wherein the clamping plates have a multilayer structure, including a structural layer to hold a desired pressure in the sealable volume, a dielectric layer for holding the retainers, and a sealing layer comprising an elastomeric material.
